(19) United States
(12) Patent Application Publication
(10) Pub. No.: US 2026/0212649 A1
(43) Pub. Date: Jul. 23, 2026

(54) TRAINING DATA CREATION DEVICE, RECORDING MEDIUM, AND TRAINING DATA CREATION METHOD

(71) Applicant: NEC Corporation, Tokyo (JP)

(72) Inventors: Yuki TANAKA, Tokyo (JP); Makoto TERAO, Tokyo (JP)

(73) Assignee: NEC Corporation, Tokyo (JP)

(21) Appl. No.: 19/434,355

(22) Filed: Dec. 29, 2025

(30) Foreign Application Priority Data
Jan. 21, 2025 (JP) 2025-008565

(51) Int. Cl. G06V 10/77; G06V 10/774

(52) U.S. Cl. CPC G06V 10/7715; G06V 10/774

(57) ABSTRACT

A training data creation device includes setting unit for setting, as a first region, at least one of a plurality of regions in which an object appears and which are extracted from an image, and selection unit for selecting, from among the plurality of regions, a second region having a feature value whose similarity to a feature value of the first region is equal to or greater than a predetermined value.

This application is based upon and claims the benefit of priority from Japanese Patent Application No. 2025-008565, filed on January 21, 2025, the disclosure of which is incorporated herein in its entirety by reference.

### TECHNICAL FIELD

The present disclosure relates to a training data creation device, a recording medium, and a training data creation method.

### BACKGROUND ART

Conventionally, various techniques for easily obtaining training data necessary for construction and performance improvement of an object detection model have been proposed. For example, JP 2022-038941 A describes a learning data collection device including a first acquisition unit, a second acquisition unit, an identification unit, and a learning data output unit. The first acquisition unit acquires a query image and a query text related to a target object. The second acquisition unit acquires candidate images of the target object by using the query text. The identification unit identifies a positive example image including a region whose similarity to the query image is equal to or greater than a threshold and a position of the region in the positive example image from among the candidate images by using the query image. The learning data output unit outputs learning data including information indicating the position of the region in the positive example image, the positive example image, and a correct answer label based on the query text.

### SUMMARY

The present disclosure has been made in view of the above problems, and an object thereof is to provide a technique capable of easily annotating each of a plurality of target objects to be detected appearing in one image in creation of training data.

A training data creation device according to an exemplary aspect of the present disclosure includes setting means for setting, as a first region, at least one of a plurality of regions in which an object appears and which are extracted from an image, and selection means for selecting, from among the plurality of regions, a second region having a feature value whose similarity to a feature value of the first region is equal to or greater than a predetermined value.

A program according to an exemplary aspect of the present disclosure causes at least one processor to execute setting processing of setting, as a first region, at least one of a plurality of regions in which an object appears and which are extracted from an image, and selection processing of selecting, from among the plurality of regions, a second region having a feature value whose similarity to a feature value of the first region is equal to or greater than a predetermined value.

A training data creation method according to an exemplary aspect of the present disclosure includes a setting step in which a processor sets, as a first region, at least one of a plurality of regions in which an object appears and which are extracted from an image, and a selection step in which the processor selects, from among the plurality of regions, a second region having a feature value whose similarity to a feature value of the first region is equal to or greater than a predetermined value.

### BRIEF DESCRIPTION OF THE DRAWINGS

Exemplary features and advantages of the present disclosure will become apparent from the following detailed description if taken with the accompanying drawings in which:

FIG. 1 is a block diagram illustrating an example of a functional configuration of a training data creation device according to a first example embodiment of the present disclosure;

FIG. 2 is a flowchart illustrating an example of a flow of a training data creation method according to the first example embodiment of the present disclosure;

FIG. 3 is a block diagram illustrating an example of a functional configuration of a training data creation system including a training data creation device according to a second example embodiment of the present disclosure;

FIG. 4 is a diagram illustrating an example of an image displayed on a display device by a training data creation device;

FIG. 5 is a diagram illustrating another example of the image displayed on the display device by the training data creation device;

FIG. 6 is a flowchart illustrating an example of a flow of a training data creation method according to the second example embodiment of the present disclosure; and

FIG. 7 is a block diagram illustrating a hardware configuration of a computer that functions as the training data creation device according to the present disclosure.

### EXAMPLE EMBODIMENT

Hereinafter, example embodiments of the present disclosure will be exemplified. However, the present disclosure is not limited to the following example embodiments, and various modifications may be made within the scope described in the claims. For example, example embodiments obtained by appropriately combining technical means adopted in the example embodiments described below can also be included in the scope of the present disclosure. Example embodiments obtained by appropriately omitting some of the technical means adopted in the following example embodiments may also fall within the scope of the present disclosure. Effects mentioned in the following example embodiments are examples of effects expected in the example embodiments, and do not define the extension of the present disclosure. That is, example embodiments that do not exert the effects mentioned in the following example embodiments may also fall within the scope of the present disclosure.

### First example embodiment

First, a first example embodiment, which is an example of example embodiments of the present disclosure, will be described in detail with reference to the drawings. The present example embodiment is a basic form of each example embodiment described below. An application range of each technical means adopted in the present example embodiment is not limited to the present example embodiment. That is, each technical means adopted in the present example embodiment can also be adopted in another example embodiment included in the present disclosure as long as no particular technical problem occurs. Each technical means illustrated in the drawings referred to for describing the present example embodiment can also be adopted in another example embodiment included in the present disclosure as long as no particular technical problem occurs.

### Configuration of training data creation device 1

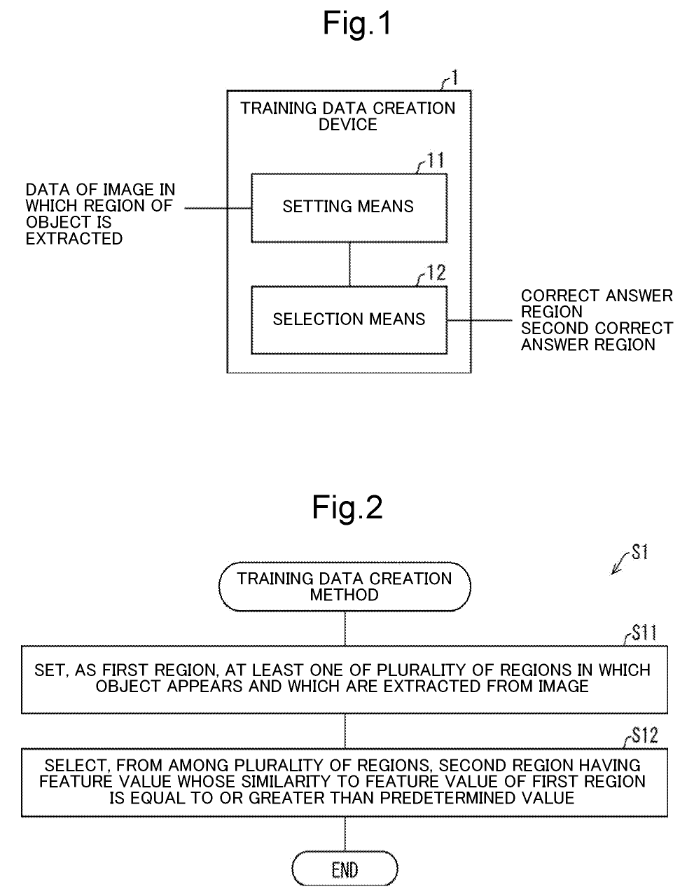

Next, a configuration of a training data creation device 1 will be described with reference to FIG. 1. FIG. 1 is a block diagram illustrating a configuration of the training data creation device 1. As illustrated in FIG. 1, the training data creation device 1 includes setting means 11 and selection means 12.

### Setting means 11

The setting means 11 sets, as a first region R1, at least one region R0 among a plurality of regions R0 in which an object appears and which are extracted from an image. The at least one region R0 may be selected by a user or may be selected by an existing inference model or the like.

### Selection means 12

The selection means 12 selects, from among the plurality of regions R0, a second region R2 having a feature value whose similarity to a feature value of the first region R1 is equal to or greater than a predetermined value. The “predetermined” in the similarity is a reference (threshold) for determining whether the similarity is high (sufficiently similar to the feature value of the first region R1).

### Effects of training data creation device 1

The training data creation device 1 described above has a configuration in which the selection means 12 selects, from among the plurality of regions R0, the second region R2 having a feature value whose similarity (to the feature value of the first region R1) is equal to or greater than the predetermined value. That is, if an object is selected (the first region R1 is set), the training data creation device 1 automatically selects another object (second region R2) which is the same as or similar to the selected object. This simplifies (substantially eliminates the necessity of) at least work of surrounding an object with a bounding box (hereinafter, BB) in annotation work. Therefore, according to the training data creation device 1 of the present example embodiment, it is possible to easily annotate each of a plurality of target objects to be detected appearing in one image in creation of training data.

In a case where a large number of target objects to be detected appear in an image serving as a source of creating training data, it is necessary to perform annotation on all the target objects (work of enclosing the target objects with bounding boxes and categorizing the target objects as necessary). However, the conventional technique described in JP 2022-038941 A can create a plurality of pieces of training data each including one annotated target object, but cannot annotate each of a plurality of target objects appearing in one image.

According to one exemplary aspect of the present disclosure, it is possible to easily annotate each of a plurality of target objects to be detected appearing in one image in creation of training data.

### Flow of training data creation method S1

Next, a flow of a training data creation method S1 will be described with reference to FIG. 2. FIG. 2 is a flowchart illustrating a flow of the training data creation method S1. As illustrated in FIG. 2, the training data creation method S1 includes a setting step S11 and a selection step S12.

### Setting step S11

After a calculation step S15, the processing proceeds to the setting step S11. In the setting step S11, at least one processor sets, as the first region R1, at least one region R0 among a plurality of regions R0 in which an object appears and which are extracted from an image. The processor that sets the first region R1 may be included in the training data creation device 1 or may be included in another device.

### Selection step S12

After the setting step S11, the processing proceeds to the selection step. In the selection step S12, the at least one processor selects the second region R2 having a feature value whose similarity to the feature value of the first region R1 is equal to or greater than a predetermined value from among the plurality of regions R0. The processor that selects the second region R2 may be included in the training data creation device 1 or may be included in another device.

### Effects of training data creation method S1

As described above, in the training data creation method S1, the at least one processor selects the second region R2 having a feature value whose similarity (to the feature value of the first region R1) is equal to or greater than the predetermined value from among the plurality of regions R0 in the selection step S12. That is, in the training data creation method S1, if an object is selected (the first region R1 is set), another object (second region R2) which is the same as or similar to the selected object is automatically selected.

This simplifies (substantially eliminates the necessity of) at least work of surrounding an object with a BB in annotation work. Therefore, according to the training data creation method S1 of the present example embodiment, it is possible to easily annotate each of a plurality of target objects to be detected appearing in one image in creation of training data.

### Second example embodiment

Next, a second example embodiment, which is an example of the example embodiments of the present disclosure, will be described in detail with reference to the drawings. Components having the same functions as the components described in the above-described example embodiment are denoted by the same reference signs, and the description thereof will be appropriately omitted. An application range of each technical means adopted in the present example embodiment is not limited to the present example embodiment. That is, each technical means adopted in the present example embodiment can also be adopted in another example embodiment included in the present disclosure as long as no particular technical problem occurs. Each technical means illustrated in each of the drawings referred to for describing the present example embodiment can also be adopted in another example embodiment included in the present disclosure as long as no particular technical problem occurs.

### Configuration of training data creation system 100

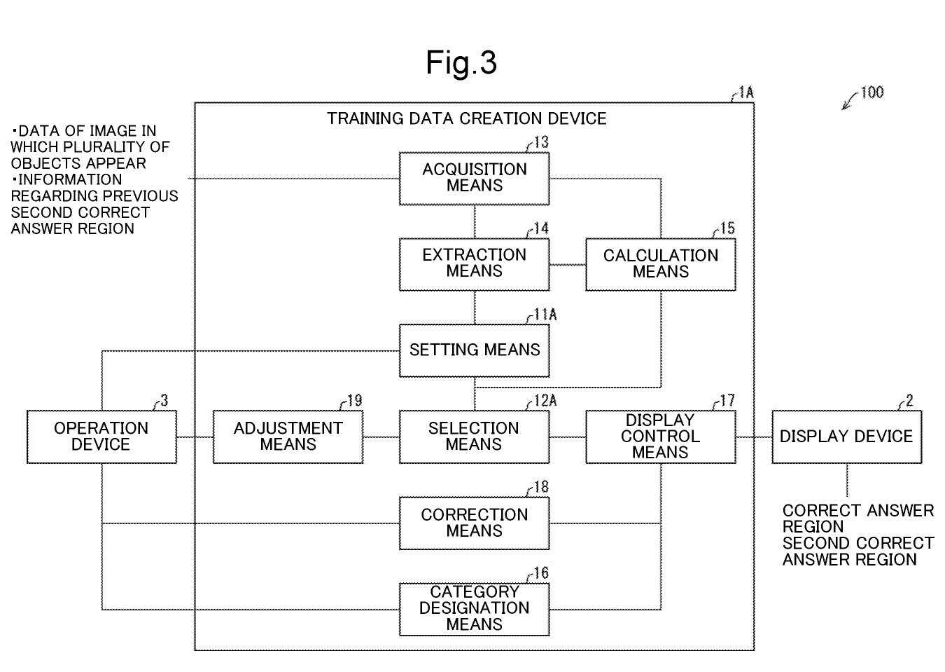

Next, a configuration of a training data creation system 100 will be described with reference to FIG. 3. FIG. 3 is a block diagram illustrating a configuration of the training data creation system 100. As illustrated in FIG. 3, the training data creation system 100 includes a training data creation device 1A, a display device 2, and an operation device 3. The display device 2 and the operation device 3 are electrically connected to the training data creation device 1A.

### Display device 2

The display device 2 displays an image acquired by the training data creation device 1A, a processing result of the training data creation device 1A, and the like. The display device 2 includes, for example, a liquid crystal display. The display device may be configured as a device independent of the training data creation device 1A or may be integrally configured with the training data creation device 1A.

### Operation device 3

The operation device 3 includes, for example, a pointing device (mouse or the like) and a touchscreen laminated on the display device 2. If operated by the user, the operation device 3 transmits a signal based on an operation mode to the training data creation device 1A.

### Configuration of training data creation device 1A

The training data creation device 1A according to the second example embodiment includes setting means 11A, selection means 12A, acquisition means 13, extraction means 14, calculation means 15, category designation means 16, display control means 17, correction means 18, and adjustment means 19.

### Acquisition means 13

The acquisition means 13 acquires data of an image in which a plurality of objects appear. The acquisition means 13 according to the second example embodiment is configured to acquire information regarding the second region R2 selected in previous training data creation.

### Extraction means 14

The extraction means 14 extracts a plurality of regions R0 from the image. The extraction means 14 according to the second example embodiment extracts the regions R0 using a learned model. Upon receiving input of data of an image, the learned model extracts the region R0 having the same shape as a BB surrounding an object for all objects (including foreground and background) appearing in the image and outputs extraction results. This learned model can include various object detection models (for example, Segment Anything Model (SAM), grounding DINO, and Detic). The extraction means 14 according to the second example embodiment acquires the output of the learned model, thereby extracting the regions R0 having the same shape as the BBs surrounding the objects.

### Calculation means 15

The calculation means 15 calculates at least feature values of the plurality of extracted regions R0 in the image. The calculation means 15 according to the second example embodiment is configured to calculate an overall feature value of the entire image and cut out the feature value of each region R0 from the overall feature value. The calculation means 15 may be configured to convert (aggregate to 1 × 1 × C) the cut-out feature value (h × w × C) using a conversion tool (average pooling or the like). The calculation means 15 may also be configured to first cut out each region R0 and calculate the feature value of each cut-out region R0.

### Display control means 17 1

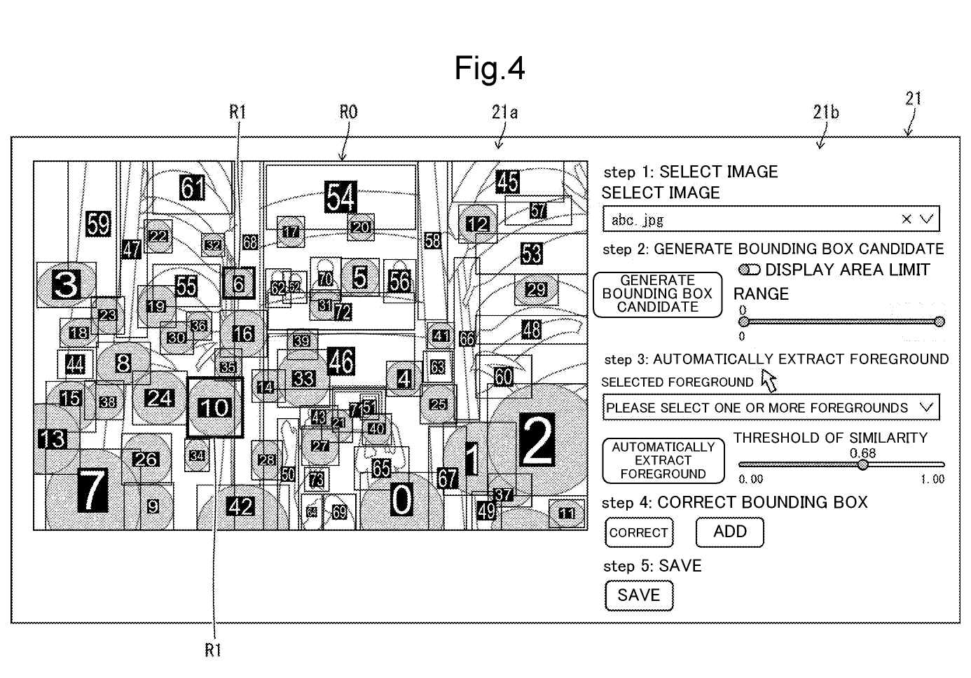

The display control means 17 performs display control of the BB. The display control means 17 according to the second example embodiment causes the display device 2 to display the BBs corresponding to contour lines of all the extracted regions R0. Specifically, the display control means 17 causes the display device 2 to display a created screen 21 as illustrated in FIG. 4. The created screen 21 includes an image display region 21a and an interface region 21b. The image display region 21a is a region for displaying an image based on acquired data. The interface region 21b is a region for displaying a bar, a button, and the like operated by the user via the operation device. Then, the display control means 17 according to the second example embodiment causes the image on which the BB surrounding each object is superimposed to be displayed in the image display region R0. The display control means 17 according to the second example embodiment further displays identification information (for example, number) of each BB in the BB. The display control means 17 may be configured to cause the display device 2 to display the image (on which no BB is superimposed).

### Adjustment means 19

The adjustment means 19 adjusts the similarity in response to an operation performed by the user on the operation device 3. The adjustment means 19 according to the second example embodiment adjusts the similarity by the user operating the operation device 3 to change a value of the similarity (for example, a position of a knob on a bar) displayed in the interface region 21b of the created screen 21.

### Setting means 11A

The setting means 11A according to the second example embodiment, as well as the setting means 11 according to the first example embodiment, sets, as the first region R1, at least one region R0 among the plurality of regions R0 in which an object appears and which are extracted from an image. The setting means 11A according to the second example embodiment sets, as the first region R1, at least one region R0 selected in response to an operation performed by the user on the operation device 3. Specifically, the setting means 11A sets, as the first region R1, a region R0 corresponding to a BB selected by the user operating the operation device 3 (for example, clicking or touching the BB or inputting the identification information of the BB) from the image on which the plurality of BBs are superimposed and which is displayed in the image display region 21a of the created screen 21. In some cases, the display control means 17 is configured to cause the display device 2 to display the image (without BB). In this case, the setting means 11A may be configured to set, as the first region R1, the region R0 including at least one designated region on the image designated in response to an operation performed by the user on the operation device 3. In this case, the setting means 11A may also be configured to set the region R0 having the largest range overlapping the designated region as the first region R1.

As described above, the acquisition means 13 according to the second example embodiment is configured to acquire information regarding the second region R2 selected in the previous training data creation. Therefore, in a case where the acquisition means 13 acquires the information regarding the second region R2, the setting means 11A according to the second example embodiment sets the acquired previous second region R2 as the first region R1.

### Display control means 17 2

After the first region R1 is set, as illustrated in FIG. 4, the display control means 17 according to the second example embodiment changes a display mode of a BB corresponding to a contour line of the first region R1 to a display mode different from a display mode of the BB corresponding to the contour line of the region R0. The display mode includes at least one of the color of the line constituting the BB, the thickness of the line, and the type of the line.

### Selection means 12A

The selection means 12A, as well as the selection means 12 according to the first example embodiment, selects the second region R2 having a feature value whose similarity to the feature value of the first region R1 is equal to or greater than a predetermined value from among the plurality of regions R0. The selection means 12A according to the second example embodiment selects a region R0 having a feature value whose cosine similarity to the feature value of the first region R1 is equal to or greater than a predetermined value (for example, about 0.8) as the second region R2. The similarity may be an index other than the cosine similarity as long as the similarity can be calculated. In a case where the setting means 11A sets a plurality of first regions R1, the selection means 12A may calculate a statistical value (for example, average value, maximum value, or median value) of feature values of the plurality of first regions R1. Then, the selection means 12A may select, as the second region R2, a region R0 having a feature value whose similarity to the statistical value is equal to or greater than a predetermined value from among the plurality of regions R0.

### Display control means 17 3

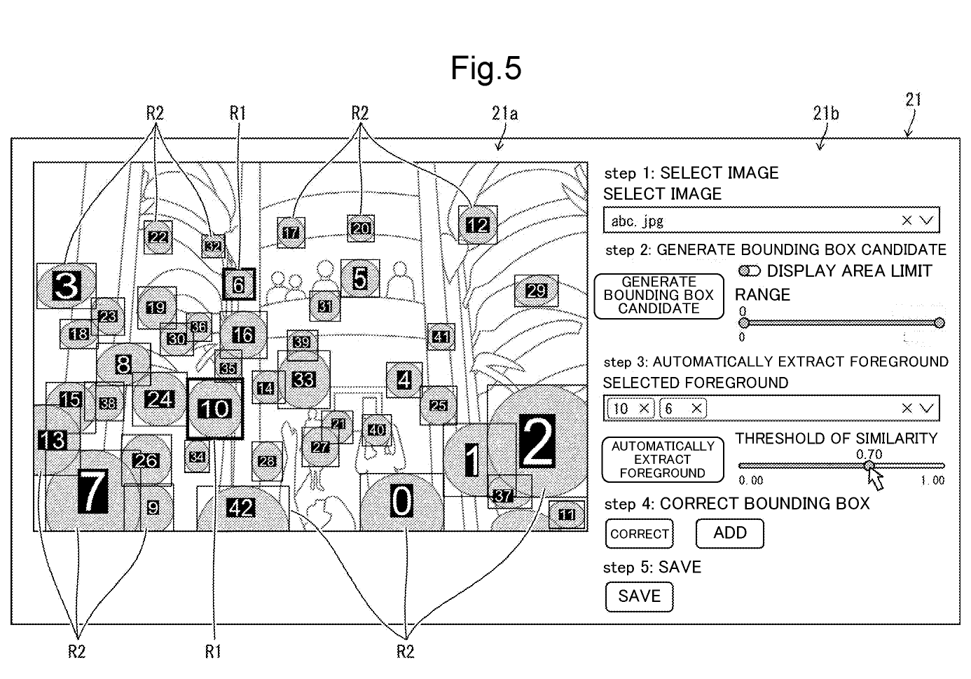

After the second region R2 is selected, the display control means 17 according to the second example embodiment brings the BB corresponding to the contour line of the first region R1 and a BB corresponding to a contour line of the second region R2 into a state of being displayed on the display device 2. As described above, after the extraction means 14 extracts the regions R0, the display control means 17 causes the display device 2 to display the BBs corresponding to the contour lines of all the extracted regions R0. Therefore, after the second region R2 is selected, the display control means 17 according to the second example embodiment stops displaying the BB corresponding to the contour line of the region R0 that is neither the first region R1 nor the second region R2. Then, as illustrated in FIG. 5, the display control means 17 continues to display only the BBs corresponding to the contour lines of the first region R1 and the second region R2. In some cases, the display control means 17 is configured to cause the display device 2 to display the image (without BB). In this case, the display control means 17 may first display only the BB corresponding to the contour line of the first region R1. Then, the display control means 17 may be configured to additionally display the BB corresponding to the contour line of the second region R2 after the second region R2 is selected.

### Correction means 18

After the second region R2 is selected, the correction means 18 executes at least one of a releasing operation and a selecting operation in response to an operation performed by the user on the operation device 3. The releasing operation is an operation of releasing the selection of one or more of the second regions R2. The selecting operation is an operation of newly selecting, as the second region R2, the region R0 that has not been selected as the second region R2.

### Category designation means 16

The category designation means 16 associates the same category with the first region R1 and the second region R2.

### Modification of training data creation device 1A

The above description has been made on the assumption that all the plurality of objects included in one image are in the same category. However, the training data creation device 1A can also annotate an image in which objects in different categories are mixed in a plurality of objects. That is, the training data creation device 1A can repeat the setting of the first region R1, the selection of the second region, and the association of a category described above for each category.

Hereinabove, closed processing performed on one image has been described. However, the training data creation device 1A can annotate another image different from an image in which the user selects the region R0. That is, the training data creation device 1A can also select, as the second region R2, the region R0 having a feature value whose similarity to the feature value of the first region R1 in one image is equal to or greater than a predetermined value from among a plurality of regions R0 in another image.

### Effects of training data creation device 1A

According to the training data creation device 1A described above, it is possible to obtain a similar effect to that of the training data creation device 1 according to the first example embodiment. That is, according to the training data creation device 1A, it is possible to obtain an effect that each of a plurality of target objects to be detected appearing in one image can be easily annotated in creation of training data.

The training data creation device 1A adopts a configuration in which the category designation means 16 associates the same category with the first region R1 and the second region R2.

Therefore, according to the training data creation device 1A, it is also possible to obtain an effect that, even in a case where target objects in different categories appear in an image, annotation can be performed by distinguishing the target objects for each category.

The training data creation device 1A adopts a configuration in which the acquisition means 13 acquires information regarding the second region R2 selected in the previous training data creation. The training data creation device 1A adopts a configuration in which the setting means 11A sets the acquired previous second region R2 as the first region R1. Therefore, according to the training data creation device 1A, it is possible to repeat selection of the second region in which the second region obtained in the previous training data creation (the region having high similarity to the first region R1 selected by the user and high reliability) is set as the first region R1. As a result, it is also possible to obtain an effect that accuracy of selecting the second region can be improved.

The training data creation device 1A adopts a configuration in which the correction means 18 executes at least one of the releasing operation and the selecting operation in response to an operation performed by the user on the operation device 3. Therefore, according to the training data creation device 1A, it is also possible to obtain an effect that erroneous selection of the second region R2 by the learned model can be corrected.

The training data creation device 1A adopts a configuration in which the adjustment means 19 adjusts the similarity in response to an operation performed by the user on the operation device 3. Therefore, according to the training data creation device 1A, it is also possible to obtain an effect that occurrence of erroneous selection of the second region R2 by the learned model can be reduced.

### Flow of training data creation method S1A

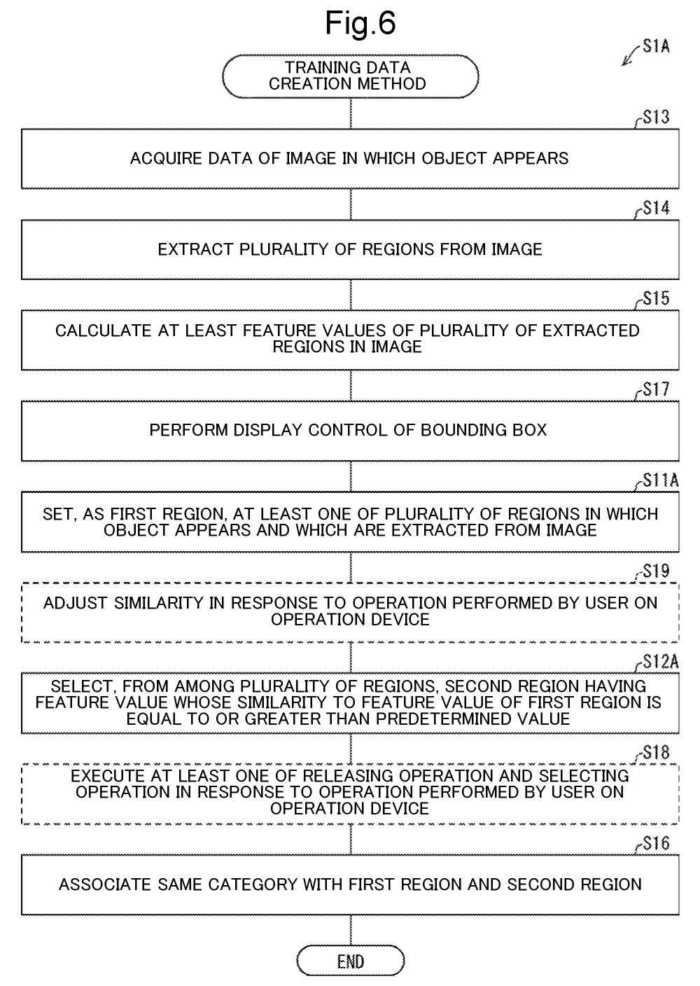

Next, a flow of a training data creation method S1A will be described with reference to FIG. 6. FIG. 6 is a flowchart illustrating the flow of the training data creation method S1A. As illustrated in FIG. 6, the training data creation method S1A according to the second example embodiment includes a setting step S11A, a selection step S12A, an acquisition step S13, an extraction step S14, a calculation step S15, a category designation step S16, a display control step S17, a correction step S18, and an adjustment step S19.

### Acquisition step S13

In the first acquisition step S13, at least one processor acquires data of an image in which an object appears. In the acquisition step S13 according to the second example embodiment, the at least one processor may acquire information regarding the second region R2 selected in the previous training data creation. The processor that acquires the data of the image may be included in the training data creation device 1A or may be included in another device.

### Extraction step S14

After the acquisition step S13, the processing proceeds to the extraction step S14. In the extraction step S14 according to the second example embodiment, the at least one processor extracts a plurality of regions R0 from the image. Further, in the extraction step S14 according to the second example embodiment, the at least one processor extracts the region R0 having the same shape as a BB surrounding the object. The processor that extracts the region R0 may be included in the training data creation device 1A or may be included in another device.

### Calculation step S15

After the acquisition step S13 or the extraction step S14, the processing proceeds to the calculation step S15. In the calculation step S15, the at least one processor calculates at least feature values of the plurality of extracted regions R0 in the image. The processor that calculates the feature values may be included in the training data creation device 1A or may be included in another device. In the calculation step S15 according to the second example embodiment, the overall feature value of the entire image is calculated, and a feature value of each region R0 is cut out from the overall feature value. In the calculation step S15, the at least one processor may convert the cut-out feature value using a conversion tool. Alternatively, in the calculation step S15, each region R0 may be first cut out, and the feature value of each cut-out region R0 may be calculated.

### Display control step S17 1

After the extraction step S14, the processing proceeds to a display control step S17. In the display control step S17, the at least one processor performs display control of the BB. In the display control step S17 according to the second example embodiment, the at least one processor causes the display device 2 to display the BBs corresponding to contour lines of all the extracted regions R0. The processor that causes the BBs to be displayed may be included in the training data creation device 1A or may be included in another device. In the display control step S17, the at least one processor may cause the display device 2 to display the image (image on which no BB is superimposed).

### Setting step S11A

After the calculation step S15, the processing proceeds to the setting step S11A. In the setting step S11A according to the second example embodiment, as well as in the setting step S11 according to the first example embodiment, the at least one processor sets, as the first region R1, at least one region R0 selected from among the plurality of regions R0. The processor that sets the first region R1 may be included in the training data creation device 1A or may be included in another device. In the setting step S11A according to the second example embodiment, the at least one processor sets, as the first region R1, at least one region R0 selected in response to an operation performed by the user on the operation device 3. In the display control step S17, the image (without BB) is displayed on the display device 2 in some cases. In this case, in the setting step S11A, the at least one processor may set, as the first region R1, the region R0 including at least one designated region on the image designated in response to an operation performed by the user on the operation device 3. In this case, in the setting step S11A, the at least one processor may set the region R0 having the largest range overlapping the designated region as the first region R1.

As described above, in the acquisition step S13 according to the second example embodiment, the at least one processor acquires information regarding the second region R2 selected in the previous training data creation in some cases. Therefore, in the setting step S11A according to the second example embodiment, in a case where the at least one processor acquires the information regarding the second region R2 in the acquisition step S13, the acquired previous second region R2 is set as the first region R1. The setting step S11A may be performed after the extraction step S14 (before the calculation step S15 or in parallel with the calculation step S15).

### Display control step S17 2

The display control step S17 according to the second example embodiment is also performed after the first region R1 is set. In the display control step S17 according to the second example embodiment, as illustrated in FIG. 4, the at least one processor changes a display mode of a BB corresponding to a contour line of the first region R1 to a display mode different from a display mode of the BB corresponding to the contour line of the region R0.

### Adjustment step S19

The adjustment step S19 is performed according to the need of the user (for example, before the selection step S12A is performed). In the adjustment step S19, the at least one processor adjusts the similarity in response to an operation performed by the user on the operation device. The processor that adjusts the similarity may be included in the training data creation device 1A or may be included in another device.

### Selection step S12A

After the setting step S11A or the adjustment step S19, the processing proceeds to the selection step S12A. In the selection step S12A, as well as in the selection step S12 according to the first example embodiment, the at least one processor selects, as the second region R2, the region R0 having a feature value whose similarity to the feature value of the first region R1 is equal to or greater than a predetermined value from among the plurality of regions R0. The processor that selects the second region R2 may be included in the training data creation device 1A or may be included in another device. In the selection step S12A according to the second example embodiment, the at least one processor selects, as the second region R2, the region R0 whose cosine similarity to the feature value of the first region R1 is equal to or greater than a predetermined value. The similarity may be an index other than the cosine similarity as long as the similarity can be calculated. In a case where the at least one processor sets a plurality of first regions R1 in the setting step S11A, the at least one processor may calculate a statistical value (for example, average value, maximum value, or median value) of feature values of the plurality of first regions R1 in the selection step S12A. Then, the at least one processor may select, as the second region R2, the region R0 having a feature value whose similarity to the statistical value is equal to or greater than a predetermined value from among the plurality of regions R0.

### Display control step S17 3

The display control step S17 according to the second example embodiment is also performed after the second region R2 is selected. In the display control step S17 according to the second example embodiment, the at least one processor brings the BB corresponding to the contour line of the first region R1 and a BB corresponding to a contour line of the second region R2 into a state of being displayed on the display device 2. As described above, in the display control step S17, after extracting the region R0 in the extraction step S14, the at least one processor causes the display device 2 to display the BBs corresponding to the contour lines of all the extracted regions R0. Therefore, in the display control step S17 according to the second example embodiment, after the second region R2 is selected, the at least one processor stops displaying the BB corresponding to the contour line of the region R0 that is neither the first region R1 nor the second region R2. Then, the at least one processor continues to display only the BBs corresponding to the contour lines of the first region R1 and the second region R2. In a case where the at least one processor causes the display device 2 to display the image (without BB) in the display control step S17, the at least one processor may first display only the BB corresponding to the contour line of the first region R1. Then, the at least one processor may additionally display the BB corresponding to the contour line of the second region R2 after the second region R2 is selected.

### Correction step S18

The adjustment step S19 is performed as necessary by the user after the second region R2 is selected. In the correction step S18, the at least one processor executes at least one of the releasing operation and the selecting operation in response to an operation performed by the user on the operation device. The processor that executes at least one of the releasing operation and the selecting operation may be included in the training data creation device 1A or may be included in another device.

### Category designation step S16

After the second region R2 is selected or after the correction step S18, the processing proceeds to the category designation step S16. In the category designation step S16, the at least one processor associates the same category with the first region R1 and the second region R2. The processor that associates a category may be included in the training data creation device 1A or may be included in another device.

### Effects of training data creation method S1A

According to the training data creation method S1A described above, it is possible to obtain an effect similar to that of the training data creation method S1 according to the first example embodiment. That is, it is possible to obtain an effect that each of a plurality of target objects to be detected appearing in one image can be easily annotated in creation of training data.

In the training data creation method S1A, a configuration in which the same category is associated with the first region R1 and the second region R2 is adopted in the category designation step S16. Therefore, according to the training data creation method S1A, it is also possible to obtain an effect that, even in a case where target objects in different categories appear in an image, annotation can be performed by distinguishing the target objects for each category.

In the training data creation method S1A, a configuration in which information regarding the second region R2 selected in the previous training data creation is acquired is adopted in the acquisition step S13. In the training data creation method S1A, a configuration in which the acquired previous second region R2 is set as the first region R1 is adopted in the setting step S11A. Therefore, according to the training data creation method S1A, it is possible to repeat selection of the second region in which the second region obtained in the previous training data creation (the region having high similarity to the first region R1 selected by the user and high reliability) is set as the first region R1. As a result, it is also possible to obtain an effect that accuracy of selecting the second region can be improved.

In the training data creation method S1A, a configuration in which at least one of the releasing operation and the selecting operation is executed in response to an operation performed by the user on the operation device 3 is adopted in the correction step S18. Therefore, according to the training data creation method S1A, it is also possible to obtain an effect that erroneous selection by the learned model can be corrected.

In the training data creation method S1A, a configuration in which the similarity is adjusted in response to an operation performed by the user on the operation device 3 is adopted in the adjustment step S19. Therefore, according to the training data creation method S1A, it is also possible to obtain an effect that occurrence of erroneous selection of the second region R2 by the learned model can be reduced.

### Example of Implementation by Software

Some or all of the functions of the training data creation devices 1 and 1A (hereinafter, also referred to as “each of the above devices”) may be implemented by hardware such as an integrated circuit (IC chip) or may be implemented by software.

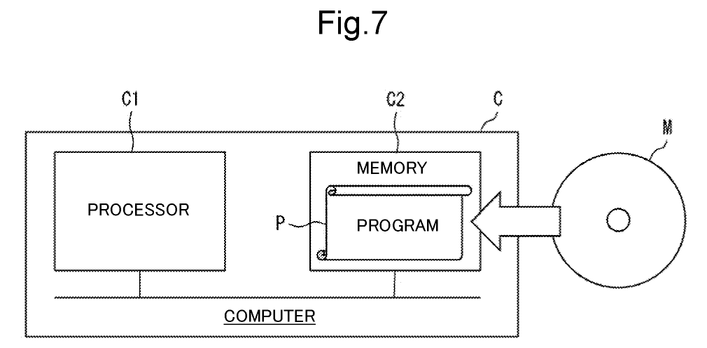

In the latter case, each of the above devices is achieved by, for example, a computer that executes a command of a program as software for achieving each function. An example of such a computer (hereinafter, referred to as a computer C) is illustrated in FIG. 7. FIG. 7 is a block diagram illustrating a hardware configuration of the computer C functioning as each of the above devices.

The computer C includes at least one processor C1 and at least one memory C2. A program P for causing the computer C to operate as each of the above means is recorded in the memory C2. In the computer C, the processor C1 reads the program P from the memory C2 and executes the program P to achieve the function of each of the above means.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from another device. The computer C may further include an input/output interface for connecting input/output equipment such as a keyboard, a mouse, a display, and a printer.

The program P can be recorded on a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can also be transmitted via a transmission medium. As such a transmission medium, for example, a communication network, a broadcast wave, or the like can be used. The computer C can also acquire the program P via such a transmission medium.

### Supplementary Note Matter 1

The present disclosure includes the techniques described in the following Supplementary Notes. However, the present disclosure is not limited to the techniques described in the following Supplementary Notes, and various modifications may be made within the scope described in the claims.

### Supplementary Note 1

A training data creation device including

setting means for setting, as a first region, at least one of a plurality of regions in which an object appears and which are extracted from an image, and

selection means for selecting, from among the plurality of regions, a second region having a feature value whose similarity to a feature value of the first region is equal to or greater than a predetermined value.

### Supplementary Note 2

The training data creation device according to Supplementary Note 1, further including

acquisition means for acquiring data of an image in which an object appears, and

extraction means for extracting the plurality of regions from the image.

### Supplementary Note 3

The training data creation device according to Supplementary Note 1 or 2, further including category designation means for associating the same category with the first region and the second region.

### Supplementary Note 4

The training data creation device according to Supplementary Note 2 or 3, in which

the extraction means extracts the region having the same shape as a bounding box surrounding the object, and

the training data creation device further includes display control means for bringing the bounding box corresponding to a contour line of the first region and the bounding box corresponding to a contour line of the second region into a state of being displayed on a display device after the second region is selected.

### Supplementary Note 5

The training data creation device according to any one of Supplementary Notes 2 to 4, in which

the extraction means extracts the region having the same shape as a bounding box surrounding the object,

the training data creation device further includes display control means for causing a display device to display the bounding boxes corresponding to contour lines of all the extracted regions, and

the setting means sets, as the first region, at least one of the regions selected in response to an operation performed by a user on an operation device.

### Supplementary Note 6

The training data creation device according to any one of Supplementary Notes 2 to 5, in which

the extraction means extracts the region having the same shape as a bounding box surrounding the object,

the training data creation device further includes display control means for causing a display device to display the image, and

the setting means sets, as the first region, the region including at least one designated region on the image designated in response to an operation performed by a user on an operation device or the region having the largest range overlapping the designated region.

### Supplementary Note 7

The training data creation device according to any one of Supplementary Notes 2 to 6, in which

the acquisition means acquires information regarding the second region selected in previous training data creation, and

the setting means sets the acquired previous second region as the first region.

### Supplementary Note 8

The training data creation device according to any one of Supplementary Notes 1 to 7, further including

correction means for executing at least one of

a releasing operation of releasing selection of one or more of the second regions, or

a selecting operation of newly selecting, as the second region, the region that has not been selected as the second region

in response to an operation performed by a user on an operation device after the second region is selected.

### Supplementary Note 9

The training data creation device according to any one of Supplementary Notes 1 to 8, further including adjustment means for adjusting the similarity in response to an operation performed by a user on an operation device.

### Supplementary Note 10

The training data creation device according to any one of Supplementary Notes 1 to 9, in which

the setting means sets, as the first region, at least one of the plurality of regions extracted from one image, and

the selection means selects, from among the plurality of regions extracted from another image different from the one image, a second region having a feature value whose similarity to a feature value of the first region is equal to or greater than a predetermined value.

### Supplementary Note 11

A program for causing at least one processor to execute

setting processing of setting, as a first region, at least one of a plurality of regions in which an object appears and which are extracted from an image, and

selection processing of selecting, from among the plurality of regions, a second region having a feature value whose similarity to a feature value of the first region is equal to or greater than a predetermined value.

### Supplementary Note 12

A training data creation method including

a setting step in which a processor sets, as a first region, at least one of a plurality of regions in which an object appears and which are extracted from an image, and

a selection step in which the processor selects, from among the plurality of regions, a second region having a feature value whose similarity to a feature value of the first region is equal to or greater than a predetermined value.

### Supplementary Note 13

The program according to Supplementary Note 11 for causing the at least one processor to further execute

acquisition processing of acquiring data of an image in which an object appears, and

extraction processing of extracting the plurality of regions from the image.

### Supplementary Note 14

The program according to Supplementary Note 11 or 13 for causing the at least one processor to further execute category designation processing of associating the same category with the first region and the second region.

### Supplementary Note 15

The program according to Supplementary Note 13 or 14 for causing the at least one processor to

in the extraction processing, extract the region having the same shape as a bounding box surrounding the object, and

further execute display control processing of bringing the bounding box corresponding to a contour line of the first region and the bounding box corresponding to a contour line of the second region into a state of being displayed on a display device after the second region is selected.

### Supplementary Note 16

The program according to any one of Supplementary Notes 13 to 15 for causing the at least one processor to

in the extraction processing, extract the region having the same shape as a bounding box surrounding the object,

further execute display control processing of causing a display device to display the bounding boxes corresponding to contour lines of all the extracted regions, and

in the setting processing, set, as the first region, at least one of the regions selected in response to an operation performed by a user on an operation device.

### Supplementary Note 17

The program according to any one of Supplementary Notes 13 to 16 for causing the at least one processor to

in the extraction processing, extract the region having the same shape as a bounding box surrounding the object,

further execute a display control step of causing a display device to display the image, and

in the setting processing, set, as the first region, the region including at least one designated region on the image designated in response to an operation performed by a user on an operation device or the region having the largest range overlapping the designated region.

### Supplementary Note 18

The program according to any one of Supplementary Notes 13 to 17 for causing the at least one processor to

in the acquisition processing, acquire information regarding the second region selected in previous training data creation, and

in the setting processing, set the acquired previous second region as the first region.

### Supplementary Note 19

The program according to any one of Supplementary Notes 11 and 13 to 18 for causing the at least one processor to further execute

correction processing of executing at least one of

a releasing operation of releasing selection of one or more of the second regions, or

a selecting operation of newly selecting, as the second region, the region that has not been selected as the second region

in response to an operation performed by a user on an operation device after the second region is selected.

### Supplementary Note 20

The program according to any one of Supplementary Notes 11 and 13 to 19 for causing the at least one processor to further execute adjustment processing of adjusting the similarity in response to an operation performed by a user on an operation device.

### Supplementary Note 21

The program according to any one of Supplementary Notes 11 and 13 to 20 for causing the at least one processor to

in the setting processing, set, as the first region, at least one of the plurality of regions extracted from one image, and

in the selection processing, select, from among the plurality of regions extracted from another image different from the one image, a second region having a feature value whose similarity to a feature value of the first region is equal to or greater than a predetermined value.

### Supplementary Note 22

The training data creation method according to Supplementary Note 12, further including

an acquisition step in which at least one processor acquires data of an image in which an object appears, and

an extraction step in which the at least one processor extracts the plurality of regions from the image.

### Supplementary Note 23

The training data creation method according to Supplementary Note 12 or 22, further including a category designation step in which at least one processor associates the same category with the first region and the second region.

### Supplementary Note 24

The training data creation method according to Supplementary Note 22 or 23, in which

in the extraction step, the at least one processor extracts the region having the same shape as a bounding box surrounding the object, and

the training data creation method further includes a display control step in which the at least one processor brings the bounding box corresponding to a contour line of the first region and the bounding box corresponding to a contour line of the second region into a state of being displayed on a display device after the second region is selected.

### Supplementary Note 25

The training data creation method according to any one of Supplementary Notes 22 to 24, in which

in the extraction step, the at least one processor extracts the region having the same shape as a bounding box surrounding the object,

the training data creation method further includes a display control step in which the processor causes a display device to display the bounding boxes corresponding to contour lines of all the extracted regions, and

in the setting step, the at least one processor sets, as the first region, at least one of the regions selected in response to an operation performed by a user on an operation device.

### Supplementary Note 26

The training data creation method according to any one of Supplementary Notes 22 to 25, in which

in the extraction step, the at least one processor extracts the region having the same shape as a bounding box surrounding the object,

the training data creation method further includes a display control step in which the at least one processor causes a display device to display the image, and

in the setting step, the at least one processor sets, as the first region, the region including at least one designated region on the image designated in response to an operation performed by a user on an operation device or the region having the largest range overlapping the designated region.

### Supplementary Note 27

The training data creation method according to any one of Supplementary Notes 22 to 26, in which

in the acquisition step, the at least one processor acquires information regarding the second region selected in previous training data creation, and

in the setting step, the at least one processor sets the acquired previous second region as the first region.

### Supplementary Note 28

The training data creation method according to any one of Supplementary Notes 12 and 22 to 27, further including

a correction step in which at least one processor executes at least one of

a releasing operation of releasing selection of one or more of the second regions, or

a selecting operation of newly selecting, as the second region, the region that has not been selected as the second region

in response to an operation performed by a user on an operation device after the second region is selected.

### Supplementary Note 29

The training data creation method according to any one of Supplementary Notes 12 and 22 to 28, further including an adjustment step in which at least one processor adjusts the similarity in response to an operation performed by a user on an operation device.

### Supplementary Note 30

The training data creation method according to any one of Supplementary Notes 12 and 22 to 29, in which

in the setting step, at least one processor sets, as the first region, at least one of the plurality of regions extracted from one image, and

in the selection step, the at least one processor selects, from among the plurality of regions extracted from another image different from the one image, the second region having the feature value whose similarity to the feature value of the first region is equal to or greater than the predetermined value.

### Supplementary Note Matter 2

The present disclosure includes the techniques described in the following Supplementary Notes. However, the present disclosure is not limited to the techniques described in the following Supplementary Notes, and various modifications may be made within the scope described in the claims.

### Supplementary Note 1

A training data creation device including

at least one processor, in which the at least one processor executes

setting processing of setting, as a first region, at least one of a plurality of regions in which an object appears and which are extracted from an image, and

selection processing of selecting, from among the plurality of regions, a second region having a feature value whose similarity to a feature value of the first region is equal to or greater than a predetermined value.

### Supplementary Note 2

The training data creation device according to Supplementary Note 1, in which

the at least one processor further executes

acquisition processing of acquiring data of an image in which an object appears, and

extraction processing of extracting the plurality of regions from the image.

### Supplementary Note 3

The training data creation device according to Supplementary Note 1 or 2, in which the at least one processor further executes category designation processing of associating the same category with the first region and the second region.

### Supplementary Note 4

The training data creation device according to Supplementary Note 2 or 3, in which

the at least one processor

in the extraction processing, extracts the region having the same shape as a bounding box surrounding the object, and

further executes display control processing of bringing the bounding box corresponding to a contour line of the first region and the bounding box corresponding to a contour line of the second region into a state of being displayed on a display device after the second region is selected.

### Supplementary Note 5

The training data creation device according to any one of Supplementary Notes 2 to 4, in which

the at least one processor

in the extraction processing, extracts the region having the same shape as a bounding box surrounding the object,

further executes display control processing of causing a display device to display the bounding boxes corresponding to contour lines of all the extracted regions, and

in the setting processing, sets, as the first region, at least one of the regions selected in response to an operation performed by a user on an operation device.

### Supplementary Note 6

The training data creation device according to any one of Supplementary Notes 2 to 5, in which

the at least one processor

in the extraction processing, extracts the region having the same shape as a bounding box surrounding the object,

further executes display control processing of causing a display device to display the image, and

in the setting processing, sets, as the first region, the region including at least one designated region on the image designated in response to an operation performed by a user on an operation device or the region having the largest range overlapping the designated region.

### Supplementary Note 7

The training data creation device according to any one of Supplementary Notes 2 to 6, in which

the at least one processor

in the acquisition processing, acquires information regarding the second region selected in previous training data creation, and

in the setting processing, sets the acquired previous second region as the first region.

### Supplementary Note 8

The training data creation device according to any one of Supplementary Notes 1 to 7, in which

the at least one processor further executes

correction processing of executing at least one of

a releasing operation of releasing selection of one or more of the second regions, or

a selecting operation of newly selecting, as the second region, the region that has not been selected as the second region

in response to an operation performed by a user on an operation device after the second region is selected.

### Supplementary Note 9

The training data creation device according to any one of Supplementary Notes 1 to 8, in which the at least one processor further executes adjustment means for adjusting the similarity in response to an operation performed by a user on an operation device.

### Supplementary Note 10

The training data creation device according to any one of Supplementary Notes 1 to 9, in which

the at least one processor

in the setting processing, sets, as the first region, at least one of the plurality of regions extracted from one image, and

in the selection processing, selects, from among the plurality of regions extracted from another image different from the one image, the second region having the feature value whose similarity to the feature value of the first region is equal to or greater than the predetermined value.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A training data creation device comprising:
one or more memories storing instructions; and
one or more processors configured to execute the instructions to:
set, as a first region, at least one of a plurality of regions in which an object appears and which are extracted from an image; and
select, from among the plurality of regions, a second region having a feature value whose similarity to a feature value of the first region is equal to or greater than a predetermined value.

2. The training data creation device according to claim 1, wherein
the one or more processors are further configured to execute the instructions to:
acquire data of an image in which an object appears; and
extract the plurality of regions from the image.

3. The training data creation device according to claim 1, wherein
the one or more processors are further configured to execute the instructions to associate the same category with the first region and the second region.

4. The training data creation device according to claim 2, wherein
the one or more processors are further configured to execute the instructions to:
extract the region having the same shape as a bounding box surrounding the object; and
cause a display device to display the bounding box corresponding to a contour line of the first region and the bounding box corresponding to a contour line of the second region after the second region is selected.

5. The training data creation device according to claim 2, wherein
the one or more processors are further configured to execute the instructions to:
extract the region having the same shape as a bounding box surrounding the object;
cause a display device to display the bounding boxes corresponding to contour lines of all the extracted regions; and
set, as the first region, at least one of the regions selected in response to an operation performed by a user on an operation device.

6. The training data creation device according to claim 2, wherein
the one or more processors are further configured to execute the instructions to:
extract the region having the same shape as a bounding box surrounding the object;
cause a display device to display the image; and
set, as the first region, the region including at least one designated region on the image, or the region having the largest range overlapping a designated region, in response to an operation performed by a user on an operation device.

7. The training data creation device according to claim 2, wherein:
the one or more processors are configured to execute the instructions to:
acquire information regarding the second region selected in previous training data creation; and
set the previous second region as the first region.

8. The training data creation device according to claim 1, wherein
the one or more processors are configured to execute the instructions to perform at least one of:
release selection of one or more of the second regions, and
newly select, as a second region, a region that has not been selected as a second region
in response to an operation performed by a user on an operation device after the second region is selected.

9. The training data creation device according to claim 1, wherein
the one or more processors are configured to execute the instructions to adjust the predetermined value for the similarity in response to an operation performed by a user on an operation device.

10. A non-transitory recording medium storing a program for causing at least one processor to execute:
setting, as a first region, at least one of a plurality of regions in which an object appears and which are extracted from an image, and
selecting, from among the plurality of regions, a second region having a feature value whose similarity to a feature value of the first region is equal to or greater than a predetermined value.

11. A training data creation method comprising:
by a computer,
setting, as a first region, at least one of a plurality of regions in which an object appears and which are extracted from an image; and
selecting, from among the plurality of regions, a second region having a feature value whose similarity to a feature value of the first region is equal to or greater than a predetermined value.
